(19) United States
(12) Patent Application Publication
(10) Pub. No.: US 2003/0228027 A1
(43) Pub. Date: Dec. 11, 2003

(54) Sub-woofer with two passive radiators

(76) Inventor: Eugene J. Czerwinski, Simi Valley, CA (US)

Correspondence Address: W. Edward Johansen, 11661 San Vicente Boulevard, Los Angeles, CA, 90049, US

(21) Appl. No.: 10/060,038

(22) Filed: Jan. 29, 2002

Related U.S. Application Data
(63) Continuation-in-part of application No. 09/523,870, filed on Mar. 14, 2000, now Pat. No. 6,343,134.
Application No. 09/523,870 is a continuation-in-part of application No. 09/014,700, filed on Jan. 28, 1998, now Pat. No. 6,038,326.
Application No. 09/523,870 is a continuation-in-part of application No. 09/973,472, filed on Oct. 9, 2001.

(51) Int. Cl. H04R 1/02; H04R 1/20

(52) U.S. Cl. 381/342; 381/351; 381/386

(57) ABSTRACT

A surround is for use in an electron-dynamic acoustical transducer. The electron-dynamic acoustical transducer includes a frame, a diaphragm and a voice coil. The surround includes a single, large, semi-circular corrugation that is constructed from compressed neoprene foam rubber and secured to the frame by the surround. The surround has a plurality of radially distributed, relatively less-compressed areas.

This application is a continuation-in-part of an application, filed Mar. 14, 2000 under Ser. No. 09/523,870, now U.S. Pat. No. 6,343,134, which is a continuation-in-part of an application, filed Jan. 28, 1998 under Serial. No. 09/014,700, now U.S. Pat. No. 6,038,326, and a continuation-in-part of an application, filed Oct. 9, 2001 under Ser. No. 09/973,472.

### BACKGROUND OF THE INVENTION

The present invention relates generally to the field of high fidelity audio reproduction and more particularly to subwoofer loudspeaker systems that produce high quality, low distortion and low-frequency sound.

U.S. Pat. No. 6,343,134 and U.S. Pat. No. 6,038,326 teach a loudspeaker that includes a compression chamber, a first electro-acoustic transducer and a horn. The first electro-acoustic transducer is disposed inside the compression chamber. The horn is mechanically and acoustically coupled to the first electro-acoustic transducer. The loudspeaker also includes a second electro-acoustic transducer. The second electro-acoustic transducer is disposed outside the compression chamber. The second electro-acoustic transducer is mechanically and acoustically coupled to the horn.

U.S. Pat. No. 4,138,594 teaches a small dimension low frequency loudspeaker that includes a folded exponential horn which provides a unitary curved sound path from an electro-acoustic transducer at the throat of the horn to a volume into which sound is radiated at the mouth of the horn. The length of the horn is such that, at an exponential rate of expansion between the throat and the mouth, the mouth, when it is bounded by at least one planar surface, such as a floor, a ceiling, and/or walls of a room, has adequate area to enable reproduction of low audible frequencies. The low frequency loudspeaker has an effective low end cut-off frequency of 55 Hz. U.S. Pat. No. 4,210,223 teaches a low frequency loudspeaker apparatus includes a folded exponential horn that is divided to provide a bifurcated curved sound path from at least one electro-acoustic transducer that is positioned at the throat of the horn to a volume into that sound waves are radiated that is located at the bifurcated mouth of the horn. The mean length of the folded exponential horn is such that, at an exponential rate of expansion between the throat and the bifurcated mouth, the area of the mouth is adequate for reproduction of low frequencies in the audible range. The low frequency loudspeaker apparatus has an effective low end cut-off frequency of 38 Hz and affords 99 dB SPL output at three meters with one watt input which corresponds to about 20% efficiency measured in free space. Presence of a single boundary surface, such as a stage floor adjacent the mouth of the folded exponential horn, improves amplitude response by 3 to 6 dB. A small dimension low frequency folded exponential horn loudspeaker has a unitary sound path for direction of acoustical waves from an electro-acoustic transducer to a volume into which the acoustical waves are radiated.

High fidelity sound reproduction requires reproduction of low audible frequencies. W. B. Snow, “Audible Frequency Ranges of Music, Speech, and Noise,” Jour. Acous. Soc. Am., Vol. 3, July, 1931, p. 155, for example, indicates that high fidelity sound reproduction of orchestral music requires that the frequency band should extend to as low as 40 Hz. It is well established that loudspeakers, in order to reproduce a given frequency range, must have dimensions based on the wavelength which corresponds to the lowest frequency in the range. In the case of one type of loudspeaker, the exponential horn loudspeaker, for example, the area of the exponential horn mouth is determined on the basis of the wavelength of the lowest frequency to be reproduced. At an early date, to obtain high fidelity sound reproduction with exponential horn loudspeakers, and, in particular, the inclusion of low audible frequencies, large exponential horn loudspeakers were constructed. For example, theater loudspeakers as large or larger than eight feet in length and four feet by four feet in transverse dimensions were built in order to obtain reproduction of low audible frequencies. Later, the outside dimensions of the exponential horns were reduced by folding, but even then the dimensions of the mouths were large for reproduction of low audible frequencies. More recently, folded exponential horn loudspeakers with reduced mouth dimensions have been used in proximity to boundary surfaces, such as a floor, a ceiling, and/or walls of a room, to increase the effective mouth area so that low audible frequencies are reproduced while at the same time the dimensions of the low frequency loudspeakers are minimized. See, for example, Sandeman, U.S. Pat. No. 1,984,550, U.S. Pat. No. 2,310,243 and U.S. Pat. No. 2,373,692, and Klipsch, “La Scala,” Audio Engineering Society Preprint No. 372, April 1965. The low frequency folded exponential horn loudspeakers, such as those which are disclosed in the above-cited references, have small dimensions and, when their mouths are located proximate planar surfaces, enable reproduction of low audible frequencies. However, each of these low frequency folded exponential horn loudspeakers is structurally complex due to the structure of the folded exponential horn that defines the sound path from the electro-acoustic transducer to the volume into which sound is radiated. Perhaps the simplest construction appears in the above-cited Audio Engineering Society publication. In that construction, the folded exponential horn is bifurcated to define a double sound path. Due to the complex structure, the production of high fidelity, small dimension, low frequency folded exponential horn loudspeakers has required considerable craftsmanship. High quality control in manufacture has been necessary to assure that the construction meet specifications. Consequently, the cost of low frequency folded exponential horn loudspeakers has been high.

U.S. Pat. No. 5,212,732 teaches a loudspeaker system of the dipole type, particularly for use in surround sound, reverberation and similar applications. A speaker system includes a pair of woofers having dual voice coil drivers mounted on oppositely facing baffles (e.g., front and rear facing). Preferably, each baffle also includes a high frequency speaker mounted thereon. On a first baffle (e.g., front), both voice coils of the dual voice coil driver and the voice coil of the high frequency speaker are driven in-phase, and on the other baffle (e.g., rear), the second voice coil of the dual voice coil driver and the voice coil of the high frequency speaker are driven out-of-phase from those from the first baffle but in-phase with one another. The coils of the speakers are driven from suitable filter circuits.

U.S. Pat. No. 5,212,732 teaches a loudspeaker system of the dipole type, particularly for use in surround sound, reverberation and similar applications. The speaker system includes a pair of woofers having dual voice coil drivers mounted on oppositely facing baffles (e.g., front and rear facing). Each baffle also includes a high frequency speaker mounted thereon. On a first baffle (e.g., front), both voice coils of the dual voice coil driver and the voice coil of the high frequency speaker are driven in-phase, and on the other baffle (e.g., rear), the second voice coil of the dual voice coil driver and the voice coil of the high frequency speaker are driven out-of-phase from those from the first baffle but in-phase with one another. The coils of the speakers are driven from suitable filter circuits. Various forms of loudspeaker systems have been developed, and the types of speakers as well as the technologies involved pertaining to woofers, tweeters, mid-range and other forms of speaker systems are well known. Stereo sound systems using front speakers with or without some form of woofer or subwoofer, along with rear and/or side speakers, have become prevalent particularly for sound systems used to reproduce sound in “home theater” video systems for playing back video motion pictures and similar program material. The typical installation comprises a pair of front speakers positioned to either side of the TV screen, preferably with a center speaker and/or a subwoofer, and along with a pair of right and left side speaker and/or a pair of left and right rear speakers.

An Audio Engineering Society (AES) paper entitled “New Factors in Sound for Cinema and Television” by Tomlinson Holman, presented at the 89th Convention of the Audio Engineering Society, Los Angeles, Calif., Sep. 21-25, 1990, and reprinted in the Journal of the AES, Volume 39, No. 7/8, (preprint #2945) notes that the best directivity pattern for the “surround” loudspeakers is not the conventional forward radiating direct radiator, but rather dipolar radiation with the principal lobes of the dipole pointed, not at the listening area, but at the room surfaces with the null in the radiation pattern pointed at listeners, and that the best surround loudspeaker is physically invisible.

U.S. Pat. No. 4,733,749 teaches a loudspeaker system for low frequencies has a manifold chamber into which oppositely mounted and aligned woofer units radiate sound. The chamber radiates the sound perpendicularly to the woofer axes, either directly into space or into a horn. An additional back woofer may radiate directly in the perpendicular direction. An arrangement of speakers for a low-frequency sound reproduction is system particularly adapted for high power output and has manifold for coupling multiple low frequency loudspeakers, in a single sound-radiating enclosure. Multiple loudspeakers are often used in sound applications requiring high acoustic power output (sound volume), such as in theaters or arenas, or for studio and stage monitoring, discotheques and the like. In many sound systems, several components, such as driver/horn assemblies or cone/enclosure loudspeakers, are used for sound reproduction across the entire range of audible sound, with different devices covering the bass (low-frequency), midrange and high-frequency portions of the sound spectrum.

Low-frequency speakers are customarily referred to as “woofers”. A particular sound application may require an especially high power output across the whole audio spectrum. With respect to the low-frequency range, this has been accomplished in the past, in general, by increasing the number of loudspeakers, because of the need to set large volumes of air in motion to create high acoustic power. In order to move large air volumes, the excursion of a moving diaphragm having a given cone area could be increased, but since acoustic distortion increases with increasing excursion once the linear limitation of the loudspeaker suspension is reached, the solution of using multiple loudspeakers is generally preferred. Multiple loudspeakers are conventionally mounted on a front baffle board of a speaker housing or enclosure. The housing may be closed, or may be provided with one or more phase-inverting ports or ducts (as in a bass-reflex type enclosure). Acoustic coupling and addition occurs in such structures at frequencies where the wavelengths are sufficiently greater than the distances between the individual speakers or phase-inverting ports.

U.S. Pat. No. 4,391,346 and U.S. Pat. No. 4,437,540 teach individual speaker units which are set in the walls of a cavity behind a front baffle board. The speaker units are arranged so that the sound-radiating axis of each speaker unit angularly converges on and is concentrated on a point of the central axis of the cavity, just behind the front baffle, toward which the speakers are generally aimed. While such an arrangement may improve midrange sound reproduction, low-end frequency reproduction is adversely affected, as the cavity behaves like a short acoustic horn having a rapid flare rate, such a horn being incapable of sustaining very low-frequency sounds. A maximum output speaker system for high-volume sound. A more specific object is to provide an efficient arrangement for summing the outputs of a number of individual low-frequency speakers for radiation from a single sound-radiating aperture. The maximum output speaker system minimizes destructive sound interference and maximizes coupling between loudspeakers at low frequencies. The sound-radiating axes of the individual speaker units are not aimed towards the chamber exit. Instead, pairs are aimed directly at or away from each other. This optimizes low frequency performance without peaking medium-pitch sound. The manifold chamber exit is smaller than the sum of the diaphragm areas of the individual speakers inside the chamber.

U.S. Pat. No. 3,903,989 teaches a loudspeaker system that has a cabinet with two compartments, a first of which contains a low-frequency loudspeaker for producing an omni-directional radiation pattern, and the second compartment, above the first, containing a rotationally adjustable vertically oriented baffle on that are supported additional loudspeaker motors designed to cover the mid-and high-frequency bands of the audio frequency spectrum. The baffle is so shaped and the additional loudspeaker motors located in positions thereon that they operate as high-efficiency gradient or dipole loudspeakers over a significant portion of their respective frequency ranges. The directivity of the loudspeaker system can be controlled by adjustment of the position of the baffle relative to the cabinet. It is conventional in loudspeaker systems to divide the audio frequency range of interest between a plurality of individual loudspeaker drivers mounted in a common enclosure, the higher quality systems utilizing a low frequency driver, or “woofer” for the very low frequencies, a smaller driver for the lower mid-range of frequencies, a still smaller driver for upper mid-range frequencies, and one or more “tweeters” for the high-frequency range. Because the wavelengths of the mid-and high-frequency signals are shorter than those of the low frequency signals, the directivity of the mid- and high-frequency signals of any particular drive is sharper than that of the low frequency signals. Accordingly, the sound field produced by an output signal from a given loudspeaker driver is increasingly narrower with increase in the signal frequency, with the consequence that the mid- and high-frequency signals are severely attenuated in directions offset greater than about 30 degrees to 60 degrees from the central axis of the loudspeaker array, depending on the dimensions of the driver and the frequency of the signal. The nature of this problem is described in detail in a paper by this applicant entitled “Broadening the Area of Stereophonic Perception” which appeared in the Journal of the Audio Engineering Society, Vol. 8, No. 2, pp. 91-94 (1960), and a loudspeaker arrangement representing a solution to the problem is described and claimed in U.S. Pat. No. 3,080,012. The problem as it applies to quadraphonic reproduction is described in a paper entitled “Quadrophony Needs Directional Loudspeakers” which appeared in the March 1973 issue of Audio Magazine, pages 22, 24, 26 and 30.

U.S. Pat. No. 4,437,541 teaches a controlled dispersion loudspeaker configuration in which a loudspeaker is mounted through a hole in a front baffle forming a seal between the speaker and the baffle. A rear baffle is parallely spaced a predetermined distance away from the front baffle by means of spacers. Acoustically absorptive material is placed between the two baffles and is acoustically open on at least two opposite sides. The sound waves from the rear of the speaker exit from the acoustic material and serve to cancel the sound waves at the sides and rear of the loudspeaker configuration eminating from the front of the speaker. The size of the baffles, as well as the spacing therebetween, bears a particular relationship to the frequence of the sound to be reproduced by the loudspeaker.

U.S. Pat. No. 6,130,954 teaches a small, compact subwoofer cabinet that has openings in two cabinet walls; first and second cages mounted on respective ones of the walls in alignment with the openings; a voice coil driven driver including an annular magnet weighing approximately 225 oz affixed to the first cage; a stationary pole piece extending through the magnet and defining a magnetic gap therebetween; a voice coil mounted on a cylindrical voice coil former positioned within the gap; a cone affixed to one end of the former; a first flexible surround secured to the outer end of the cone and to the first cage; a flexible spider secured to the former and to the first cage; a mass driven driver including a mass aggregating about 2 lbs; a second flexible surround secured to the mass and to the second cage; a flexible spider attached to the second cage and to the mass; both surrounds having a thickness of about 0.1″, an edgeroll having a diameter of about 1.5″, and capable of standing off internal pressures of up to about 3 lbs/in.sup.2; a drive amplifier capable of delivering up to about 2,700 watts to a nominal 4 ohm resistive load and swinging up to about 104 volts for delivering (+).DELTA.v and (−).DELTA.v drive signals to the voice coil for driving the voice coil driven driver through a peak-to-peak stroke of about 2.5″ while generating a large back emf sufficient to counter the applied emf and minimize current flow in the voice coil.

In the field of high fidelity sound reproduction, a high quality audio system is normally includes a signal source, a preamplifier, a power amplifier and a loudspeaker. The signal source is generally music or soundtracks from films, compact disk players or laser disk players. The preamplifier receives signals from the signal source and provides an audio signal to the power amplifier that amplifies the signal. The loudspeakers can reproduce the sound from the signal source. Loudspeakers are single enclosures designed to produce most of the audible frequency range, which is from 20 Hertz (Hz) to 20,000 Hz. Modern recording technologies have allowed music and film producers to make recordings having wider dynamic ranges resulting in higher signal-to-noise ratios and more extended frequency response. Many music and film recordings contain more low frequency information than those of only a few years ago. This is especially true in film soundtracks, where recordings of special effects such as explosions are commonplace. In response to the increased low frequency sound in recordings, a growing number of audio systems are adding an additional type of loudspeaker to their existing array of loudspeakers. This type of loudspeaker is known as a “subwoofer”. Subwoofers are specialized loudspeakers that reproduce only the lowest frequencies of the audible frequency range meaning those frequencies ranging from approximately 20 Hz to about 80 to 120 Hz. Reproducing these low frequency sounds is difficult for the full-range loudspeakers because the bass drivers for full range loudspeakers must handle a wider frequency range in that their frequency response must extend much higher in the audible frequency range, often to about 2,500 Hz or even higher depending upon the design of the loudspeaker. Adding a subwoofer to an audio system relieves the full range loudspeaker from reproducing the lowest frequencies, thereby improving its performance. Certain standards are being set for the reproduction of film soundtracks at home which require the use of one or more subwoofers. Such standards include THX (a registered trademark of Lucas Film, Ltd.) certification from Lucas Film and Dolby AC-3 Surround Sound (a registered trademark of J. C. Penney Company, Inc.) from Dolby Laboratories. Dolby AC-3 Surround Sound even has an audio channel dedicated to only low frequency information. Conventional design of a subwoofer involves the placement of one or more large bass drivers into a large cabinet—e.g., typically a cabinet enclosing a volume of space ranging from about 8 cubic feet to about 27 cubic feet. Bass drivers, known as “woofers”, generally include a circular “diaphragm” or “cone” which can be constructed of many different materials including paper, plastic and kevlar. Woofer cones have a certain diameter in that bore of the cone is equal to pi.times.radius.sup.2 (.pi.r.sup.2). Subwoofer cones capable of high acoustic output generally have a diameter of at least ten inches. The circumference of the cone is affixed to a “surround,” which is a suspension, which is affixed to the driver's frame. The suspension enables the cone to move in and out of the driver frame at a particular frequency and returns it to a null position when no sound is produced. The peak-to-peak distance traveled by the cone is known as the “stroke” of the driver—sometimes referred to as the “excursion” of the driver. The drivers installed in subwoofers have a peak-to-peak stroke or excursion of between 0.4″ and 0.6″. Suspensions are constructed of flexible, compliant materials such as relatively thin rubber, impregnated cloth, expanded synthetic cellular foam such, such as expanded cellular polyethylene (“PE”) surround foam, which is compressed to a thickness of about 0.02″ and which is not self-supporting, which have historically produced very little resistance to peak-to-peak cone movement, and which are capable of standing off box pressures of only on the order of nominally about 0.1 lbs/in.sup.2 and, at best, only about 0.15 lbs/in.sup.2. Movement of the cone about the suspension causes air to be moved, which is what produces the sound heard and, in the case of bass, felt by the listener. The amount of air that can be moved by a driver is directly related to the bore and stroke of the subwoofer cone. Thus, to increase the amount of air that a subwoofer can move, the bore, the stroke, and/or both the bore and stroke, can be increased. However, and as will be discussed below, simply increasing the bore and/or the stroke has disadvantages. At the center of the cone, the driver is affixed to the “motor” of the cone that is comprised generally of a single electrical conductor placed within a magnetic field. In the prior art, the electrical conductor is a single electrical wire wrapped around a cylinder. This arrangement is known as the “voice coil” of the driver. The voice coil is wrapped around a voice coil former that is, in turn, affixed to the cone of the driver and placed in proximity to a magnet. When current is run through the voice coil, magnetic fields are created around the voice coil. These voice coil magnetic fields interact with the magnetic fields of the magnet, which causes the voice coil former to move. Movement of the voice-coil former causes the movement of the cone. Movement of the cone causes movement of air. The movement of air produces sound. Producing sound at higher volumes requires greater movements of the cone. Greater movements of the cone are produced when the voice coil and the magnet of the driver have greater magnetic field interactions. This increased magnetic field interaction is produced when the voice coil has more current running through it. To reproduce low frequencies at high volume levels, a subwoofer must be capable of moving large quantities of air. A subwoofer for use in the home can move approximately one-hundred thirty cubic inches of air. For louder audio volumes, it is desirable that the subwoofer be capable of moving even more air, such as one hundred eighty cubic inches of air. A cone of a fifteen inch diameter woofer has a diameter of approximately thirteen inches and a stroke of approximately 0.6 inches. This woofer can move approximately eighty cubic inches of air. The subwoofer will utilize two of these drivers because two drivers are able to move approximately one hundred sixty cubic inches of air. One disadvantage of having a driver with a fifteen inch cone is that it is difficult to design a cone of that size which is rigid enough to resist distortion when the cone has such a large surface area.

Another subwoofer utilizes four twelve-inch drivers. The cone of each driver has a diameter of approximately ten inches and a stroke of approximately 0.6 inches. This subwoofer can move approximately one hundred ninety cubic inches of air, but suffers from the disadvantage that four drivers are required thereby greatly not only increasing the size of the cabinet required, but also adding both cost and weight. It is possible to increase the stroke of the driver thereby increasing the amount of air that is moved by the driver. When the stroke of the driver is increased, the efficiency of the driver is substantially reduced because less of the voice coil will remain in the magnetic gap.

These subwoofers invariably require a large cabinet. One reason that many prior art subwoofers utilize several large drivers is so that they can move enough air for adequate performance. Large cabinets are necessary for these subwoofers for reasons having nothing to do with the number of drivers installed therein. Drivers for subwoofers are generally installed in a sealed or vented box. When the cone of the driver moves, it must overcome the forces inherently created because of the box structure itself. For instance, during operation, if the cone is moving into the cabinet, it compresses the air inside the cabinet thereby creating a force resisting inward cone movement. If, on the other hand, the cone is moving out of the cabinet, it creates a vacuum that exerts a force tending to pull the cone back into the cabinet. These conditions exist for both sealed and vented boxes or cabinets. Atmospheric pressures outside the cabinet also affect these forces. The driver must overcome the foregoing forces during movement of the cone. The higher the pressure to be overcome (whether positive or negative) means that the more power that is required to overcome that pressure. The physical structure of the subwoofer can be manipulated to deal with the increase in power that is requited to overcome the foregoing forces. First, a larger enclosure can be used. A larger enclosure will create less resistance to inward and outward cone movements because it contains more air than a smaller enclosure. The reason for this is that when the driver cone moves into the cabinet, the larger air volume is compressed to a lower pressure. Less power is required by the voice coil to overcome the forces created by the compression of air within the cabinet. When the cone of the driver moves out of the cabinet, it creates less vacuum which therefore allows the voice coil to move the cone with less power. These subwoofers have utilized relatively large cabinets.

A second design factor is related to the stroke of the driver. If the stroke of the driver is short, the cone of the driver will have physical limitations on how far it can enter into the cabinet and how far it can extend outwardly from the cabinet. The shorter the extension of the driver cone into the cabinet means that the less air that will be compressed within the cabinet. Such a movement will require less power into the voice coil to effectuate movement of the cone. The same holds true for extension of the cone out of the cabinet. The shorter the extension of the cone of the driver out of the cabinet, it will create less of a vacuum so that less power that will be required for movement of the cone.

A power amplifier may provide power to a subwoofer. A subwoofer may use a separate power amplifier. However, for ease of packaging, a subwoofer may alternatively utilize a power amplifier that is built into the cabinet of the subwoofer. The power amplifier is capable of creating between one hundred to three hundred watts of power. Large amounts of power are required to drive the subwoofer for many of the reasons described above. A power amplifier capable of providing such power levels tends to create large amounts of heat that, in turn, requires large heat sinks, massive power reserve capacitors and large transformers all of which are large in size, heavy, and expensive. All of these factors are undesirable and tend to reinforce the need for a relatively large cabinet.

As can be seen from the foregoing, because of the large power demands required by a subwoofer and the large cost involved in providing large amounts of power amplification, the subwoofer has invariably required the use of a large cabinet which has held a driver having a large diameter and a short stroke. Such an arrangement allowed the subwoofer to move reasonable amounts of air without distortion. Normal listening environments often do not have space for such a large cabinet. Therefore, there is a need for a subwoofer system capable of producing low frequency information at high listening volumes that is packaged in a small volume cabinet. For many years the design of audio woofers has been predicated on conventional wisdom commonly referred to as “Hoffman's Iron Law” which provides: Eff.=V.sub.BOX/f.sub.0.sup.3=kV.sub.BOX/f.sub.0.sup.3 [1] where f.sub.0 is the desired low frequency cutoff or limit for the subwoofer; V.sub.BOX is the volume of the cabinet; and, Eff. is the efficiency of the subwoofer. Unfortunately, if one wishes to reduce the low frequency cutoff (f.sub.0) from, for example, 50 Hz to 18 Hz while retaining the same efficiency, the volume of the woofer cabinet must be significantly increased. Or, if one wishes to decrease box volume from, for example, 1 cubic foot to 0.4 cubic foot and, at the same time, decrease the low frequency cutoff (f.sub.0) from, for example, 50 Hz to 18 Hz, efficiency drops by a factor of approximately 53. Consequently, the woofer designer finds that where a 50 watt or 100 watt amplifier might have operated a 1 cubic foot woofer at a 50 Hz low frequency cutoff, a 0.4 cubic foot box at 18 Hz low frequency cutoff will require an amplifier that is approximately 53 times larger than conventional. A loudspeaker in a 1 cubic foot box with a low frequency cutoff of 50 Hz and one percent (1%) efficiency will normally operate satisfactorily if it employs a 200 watt amplifier. If a designer arbitrarily decides to reduce the box volume to 0.4 cubic foot and lower the frequency cutoff to 18 Hz, the wattage requirement for the amplifier would be 10,600 watts. This would be ludicrous and is neither practical, cost effective nor economically feasible from a commercial standpoint. In essence, Hoffman's Iron Law forbids one from making a subwoofer having a small volume box, high efficiency and low frequency cutoff. Designers of subwoofers have not deviated from religious adherence to such theories. If the designer wants to have a highly efficient bass driver for a highly efficient woofer that can have a very low frequency cutoff, the box must be huge. Conversely, if the designer wishes the box to be small, there has heretofore been no way to get a lot of bass out of it, either low or loud, with high efficiency. At the same time, speaker designers have been taught, and have believed, that there is an optimum size for magnets employed in voice coil driven woofers. It has been assumed that if the magnet is too small, the speaker will not work at all, but if the magnet is too large, only a small percentage of the output wattage from the power amplifier will be applied to the voice coil. Consequently, the designers have concluded that an optimum magnet must lie somewhere between “too small” and “too large” in order to produce effective power in the voice coil. Virtually all subwoofers will employ a magnet that weighs on the order of only about 20 ounces or less. Even in the face of today's highly advanced technologies, speaker designers still believe that a well designed, commercially marketable subwoofer should employ a relatively large cabinet that is from about eight to about twenty-seven cubic feet, multiple large drivers, drivers with peak-to-peak strokes generally on the order of not more than 0.4 inch to 0.6 inch, magnets weighing, on average, not more than 20 ounces and, at the very most, about 40 ounces; low internal box pressures of on the order of only about 0.1 pounds per square inch and surrounds that are very compliant leading to surrounds that are, at best, flimsy and incapable of supporting the components of a moving driver without wobble and consequent degradation of the audio sounds generated. The problem of attempting to design a woofer which is small in size and defining an enclosed volume of space of about 0.4 cubic foot to about 0.5 cubic foot having a low cutoff frequency below about 40 Hz, and which is, at the same time, efficient, has defied solution. Louis D. Fielder of Dolby Laboratories, Inc. and Eric M. Benjamin have stated in an article entitled “Subwoofer Performance for Accurate Reproduction of Music”, J. Audio Eng. Soc., Vol. 36, No. 6, June 1988, pages 443 through 454 at page 446: For the required value of 0.0316 acoustic watts at 20 Hz, this results in a volume excursion of 41.8 cubic inches. For a single 12 inch woofer [effective piston diameter 10 inches this would require a peak linear excursion of 0.53 inch. This large excursion requirement can be reduced by using larger drivers, increasing the number of drivers and utilizing the low-frequency boost provided by the room. With four 15 inch woofers the peak linear excursion required is 0.078 inch, neglecting room effects.” In short, the “solution” advocated by the authors, who are accredited experts that were then attempting to establish design criteria for the performance of subwoofers to be used for the reproduction of music in the home, is to design a woofer having a peak linear excursion of 0.53 inch, to attempt to reduce this “large excursion” of 0.53 inch by using larger drivers and increasing the number of drivers and the size of the box or subwoofer cabinet, and utilizing the low frequency boost provided by the listening room. Those skilled in the art relating to subwoofers will recognize that the efficiency of a subwoofer is proportional to the size of the box or cabinet that the subwoofer is mounted in. Therefore, a box or cabinet that is 1/10th the size of a conventional subwoofer box or cabinet would ordinarily be ten times less efficient than its counterpart. Under those circumstances, ten times more heat is developed in the voice coil regardless of the efficiency of the driving amplifier. Consequently, the voice coil will soon overheat and that has been a major stumbling block to the development of very small, but powerful, subwoofers. A subwoofer may be characterized by its high efficiency and, at the same time, its extremely small box or cabinet. The broad concept flies in the face of all known subwoofer computer modeling programs as well as the teachings in the literature. In this connection, those skilled in the art will appreciate that raw driver efficiency is expressed as: Eff.=(B1).sup.2/r.sub.e [2] where “B” is the magnetic field strength, and “1” and “r.sub.e” are constants. Rewriting equation [2] it is found: Eff.=kB.sup.2 [3] Based upon the foregoing, those skilled in the art will understand that in a subwoofer driver where B is increased by a factor of 3.3, the efficiency will be increased by a factor of approximately 10. Unfortunately when such a subwoofer driver is built and installed in a box bass output is found to be actually far less than before the magnetic field was increased. This fact is well known to those skilled in the subwoofer art so that subwoofers have evolved with magnetic fields optimized for maximum bass output. Subwoofers designed with magnets optimized for maximum bass output are very inefficient. The reason for this is because the motor of the subwoofer is operating very close to stall, a condition characterized by relatively high armature winding and heating. By increasing the magnetic field strength, the efficiency is increased, but the bass output is decreased because of the large back emf generated by the motion of the voice coil of subwoofer immersed in its magnetic field. The magnitude of the back emf is established by Lenze's Law: back emf=d.0./dt, [4] where .0.is the magnetic flux. The back emf generated acts to prevent current from flowing in the voice coil because it opposes the forward voltage impressed on the voice coil winding. With the lowered current in the voice coil, the result is less bass. It must be recognized at this point that all literature known to the inventor, the descriptive equations therein and all subwoofer computer modeling programs based on the literature make the basic assumption that the subwoofer is operating in stall in order to simplify the modeling. This assumption has been tenable because a tracking down converter drive amplifier able to deliver the high voltage necessary to overcome the back emf did not exist. Subwoofer designers have all made the simplifying assumption that the back emf at system impedance minimums is not significant. Another major problem encountered by subwoofer designers is directly related to the fact that subwoofers are exceptionally prone to hum problems induced by power line “ground loops”. Ground loops are caused by a redundant ground that runs from the wall plug or other suitable alternating current source where the subwoofer is plugged in, through the power line to where the audio signal source, such as a CD player, an F.M. tuner or a turntable, is plugged into the power line and back to the subwoofer audio input through the audio cable shields. This constitutes a loop called a “ground loop” generates a very undesirable 60 Hz hum. Subwoofers all suffer from unwanted “ground loop” induced 60 Hz hum to a greater or lesser degree. Subwoofer designers have attempted to solve the “ground loop” induced 60 Hz hum problem in various ways. One proposed solution includes the use of a balanced transformer that breaks the loop by virtue of its primary and secondary windings. The transformer can either be at the power line input (power transformer), or at the audio input (input transformer), or, for that matter, at both locations. Another attempted solution involves the use of optical couplings in which the audio signal is coupled by a light beam in that there is no ground connection. Both of the foregoing approaches have been effective in substantially reducing, but not eliminating, “ground loop” induced 60 Hz hum problems. This is because while they effectively “break” the ground(s), they do not suppress the hum voltage generated across the broken ground or grounds.

The suspension system in any loudspeaker normally includes a surround and a spider. The surround is a front or outer suspension. The spider is a rear suspension. The surround is the mechanical device and holds the outer edge of the diaphragm/cone of the loudspeaker. Often the word “roll” is used in place of “surround” when describing the front suspension. Surrounds can be constructed from several materials including rubber, compressed foam rubber (neoprene), corrugated cloth, paper and plastic. Roll surrounds have a single, large, semi-circular corrugation typically constructed from rubber, compressed foam rubber or treated fabric.

Surrounds help keep the cone centered and provide a portion of the restoring force that keeps the voice coil in the gap created between the pole piece and top plate of the loudspeaker. The surround also provides a damped termination for the edge of the cone. The choice of thickness and material type for surround construction can greatly alter the response of the loudspeaker. The spider, commonly constructed from treated corrugated fabric, also keeps the voice coil concentric to the pole piece, as well as providing a portion of the restoring force that maintains the voice coil within the gap. The stiffness of the spider can greatly affect the loudspeaker's resonance. The spider also provides a barrier for keeping foreign particles away from the gap area.

Surrounds are one of the primary-limiting factors in designing long-excursion loudspeakers. Excursion is defined as the amount of linear length the cone body can travel. With the conventional small roll diameters currently in use, the excursion is often limited by the surround's physical limits. Larger surrounds cannot be used without an attendant loss in effective cone area for a loudspeaker of given outside diameter, thus, creating an inevitable tradeoff. Excursion and cone-area are the two factors which contribute to a loudspeaker's volume displacement. The higher the volume displacement capability of a loudspeaker, the greater the ultimate low frequency output potential of the loudspeaker can be. In addition to controlling the linear motion of the cone, the surround also acts as a major centering force for the loudspeaker's voice coil. This centering force prevents the voice coil and former from rocking and rubbing against the pole piece or top plate.

The surround is typically glued to the inner top edge of a flat extension or rim on the outside of the frame of the loudspeaker. The frame also acts as the mounting flange of the loudspeaker. A significant amount of cone-area is sacrificed, relative to the loudspeaker's overall footprint (outside diameter). The cone-area is a major contributing factor to a loudspeaker's output and efficiency. The sacrifice in cone-area is seen as a necessary evil because of the need to provide an accessible mounting flange for the loudspeaker.

Current methods for replacing moving parts of a cone loudspeaker, for the purpose of repair, require special skill, tools and adhesives. Typically, the moving parts are cut away and the loudspeaker frame and motor structure (magnet and metal parts that complete the magnetic circuit) are stripped down with chemicals or hand scraped to remove adhesive residue. Once the frame is stripped, new moving parts must be glued together, aligned carefully and glued to the loudspeaker frame. This repair or replacement assembly process normally is handled by trained loudspeaker technicians and requires specialized gauges or alignment spacers for each loudspeaker, as well as a high degree of precision in order to be successful. Some current small dome loudspeakers, primarily tweeters, and compression drivers feature the ability to quickly remove and replace their moving parts. This is facilitated greatly in these designs due to the lack of a rear suspension or spider. In these designs, the diaphragm, voice-coil and surround are typically attached to a rigid frame that bolts or screws to the top plate of the loudspeaker. The frame is usually located with holes that line up to pegs on the motor structure for alignment. In such designs, the loudspeaker must be removed from its mounting location to perform the repair. One product currently on the market provides a woofer in which the motor structure (i.e. magnet, back plate, pole piece and top plate) is removed from the frame so that the voice coil can be inspected. However, the moving parts (roll, cone body, dust cap, voice coil and spider) remain attached to the loudspeaker's frame. Another product on the market provides a cone loudspeaker that features a screw-down spacer between its dual spiders or rear suspensions. The spacer screws through the frame to the top plate of the loudspeaker. The screws do not provide the necessary physical constraints to align the voice coil within the magnetic gap. This is still done with gauges (alignment spacers). The surround is glued to the frame in a conventional manner and the spider is glued to the spacer. This product fails to provide for easy field replacement of its parts. A loudspeaker must be carefully optimized for its intended task. Changes in its moving mass, motor strength, voice coil winding length/gauge/thickness or suspension compliance radically affect the performance of the loudspeaker. There are inevitable tradeoffs in the process of loudspeaker design. These tradeoffs must be carefully balanced with the intended task of the loudspeaker in mind, concert sound reinforcement, automotive sub-bass, a home-theater. With woofers, the intended enclosure type affects the design of the driver as well. An end user chooses a loudspeaker that works best in his intended application. The most expensive components of a loudspeaker are its non-moving parts, which generally include the loudspeaker frame and the motor structure. The moving parts of the loudspeaker generally represent a smaller portion of the total cost of the loudspeaker. If the user's operating conditions change, the loudspeaker may no longer be well-suited and is likely to be replaced with a more appropriate loudspeaker. Such is the case even if there is nothing wrong with the original loudspeaker and usually amounts to a relatively significant expenditure each time the operating conditions change. Some existing small dome loudspeakers, primarily tweeters, and compression drivers feature the ability to remove and replace their moving parts, in the event of failure. Different impedance diaphragms are offered that will work in the same motor structure. The basic mission of the loudspeaker is not changed, only the load presented to the amplifier. However, the prior art fails to provide for reconfiguring the same motor structure in the field for different applications and enclosure types, specifically for low frequency woofers. Additionally, the prior art fails to provide for a loudspeaker design that provides for relatively quick field replacement of the moving parts of a cone type loudspeaker, and in more particular to cone type loudspeakers which feature a rear suspension or spider in addition to the surround. The prior art also fails to provide a surround that is attached to the outer edge of the loudspeaker frame for improved overall displacement capability. Furthermore, the prior art fails to provide for a removable surround. It is therefore, to the effective resolution of the aforementioned problems and shortcomings of the prior art that the present invention is directed.

U.S. Pat. No. 4,433,214 teaches an electro-dynamic acoustic transducer with a slotted piston suspension system. Use of the slotted piston suspension results in greater linear excursions by relieving stresses within the diaphragm during the movement and allows operation of a transducer with greater magnet size and greater radiating areas of diaphragm suspension thereby improving overall efficiency of the transducer. The slotted piston suspension can be utilized with electro-dynamic acoustic transducers operating in the range of 200 to 20,000 cycles per second.

The piston suspension assemblies of many different shapes have been devised for use in cone displacement electro-dynamic acoustical transducers containing permanent magnets in order to provide the electromagnetic fields required for operation. Small acoustical transducers are inexpensive and are typically found in portable two-way radio communications devices or personal electronic radio receiving apparatus. In order to allow adequate expansion of the sound-radiating dome, which will result in improved linear excursions during operation, small electro-dynamic acoustic transducers require much larger piston suspensions than exist today. The piston suspension assemblies are often fraught with many different types of stresses that occur at different positions within the plane of the sound radiating dome and piston suspension during cone displacement. One such stress is a “bending” stress that occurs along the circumference of the sound radiating dome at the junction of the piston suspension. A second stress is found stretching along a plane, perpendicular to the radii of the piston suspension, in the sound-radiating dome. During operation, these stresses result in continued wear and tear of the piston suspension and sound-radiating dome, thereby causing a decrease in the performance of the transducer in its ability to produce linear excursions during operation. This will result in the acoustical transducer becoming less and less effective as operation continues over a period of time.

The piston suspensions often utilize arcuate slots contained within a flat (not curved) piston suspension. Generally, these slots, while relieving some of the stresses discussed above, create “bending” type stresses elsewhere in the piston suspension (i.e. in the material between the slots) and concentric “stretching” type stresses within the arcuate slots of the flat suspensions, which occur by the twisting motion of the sound radiating dome or cone during its displacement. The piston suspensions of acoustical transducers are generally made from any varied materials and from a material different from that which the sound-radiating dome is made. The resiliency of such materials is varied, which affects the linearity of the resulting excursions. This difference in material will introduce an additional cost in the manufacturing of the end product. The sound-radiating dome of an acoustical transducer is smaller in size for a given linear excursion, than the sound-radiating dome associated with the piston suspension. The piston suspension assembly for an electro-dynamic acoustical transducer will result in increased efficiency and improved audio quality. The acoustical transducer piston suspension assembly produces linear excursions corresponding to much larger piston suspension assemblies that exist in larger electro-dynamic transducers, thus allowing the surface area of the sound radiating dome and the size of the magnet to be increased, which will improve the efficiency of the transducer. The piston suspension assembly for a small acoustical transducer has a center sound radiating dome of which at least 80% of the total surface area of the suspension and dome thereby allowing the use of magnets which are physically larger in size than those presently used in the same-sized electro-dynamic transducers. An electro-dynamic transducer has a piston suspension assembly made of a resilient plastic film to allow the surface area of the piston suspension to be sharply curved. A sound radiating dome and piston suspension assembly has been fabricated from a unified piece of resilient plastic film, which simplifies production and reduces costs.

A small electro-dynamic acoustical transducer includes a piston suspension assembly which is sharply curved around the circumference of the center-positioned sound radiating dome and has elongated stress relieving slots integral to the surface thereof, such piston suspension being made from a resilient, flexible plastic film. An increase in the size of the over-all piston suspension will result in a proportional increase in the linear excursions of the sound-radiating dome, thereby increasing the overall performance of the transducer during operation. For the same required excursion produced by existing electro-dynamic acoustical transducers in the prior art, the piston suspension of the present invention can be made smaller in size. In this manner, the radiating area and magnet size of the electro-dynamic transducer can be maximized which will improve the operating efficiency of the transducer. The piston suspension assembly is for use with an associated electro-dynamic acoustical transducer.

The slotted piston suspension assembly includes a curved centered sound radiating dome and a curved piston suspension manufactured from the same single piece of resilient flexible plastic material. Similar materials, which can be sharply curved, may also be used. The curved piston suspension further includes stress-relieving elongated slots integral therein. The slots are positioned at predetermined intervals along the circumference of the upper surface of the piston suspension. The elongated slots have a predetermined reduced thickness relative to the thickness of the material of the surrounding piston suspension thereby preventing air that is activated in front of the sound-radiating dome from moving to the back sonic area which would normally result in sound cancellation. The slotted piston suspension assembly causes the simultaneous relief of certain bending stresses experienced along the radii of the sound radiating dome, as well as certain perpendicular concentric stresses, in such a manner as to enhance the overall effectiveness and the overall efficiency of the transducer. The slotted piston suspension is designed for use in the range of 200 to 20,000 cycles per second and has been tested and found to be highly satisfactory in use. Other piston suspensions for acoustical transducers customarily found create a number of different types of stresses during their cone displacement. One such stress is the “bending” stress along the radii of the suspension. Another stress, which is created during operation, is a “stretching” stress that is perpendicular to the radii of the suspension in the plane of the soundradiating dome. There will exist certain concentric stretching stresses in the strips between the slots. Concentric arcuate slots in the plane of a flat cone are introduced. These slots will relieve bending stresses along the radii of the piston suspension, they will create bending stresses in the strips between the slots and create other concentric stretching stresses when the sound radiating dome twists during resulting displacement. This twisting motion is nonlinear and undesirable.

U.S. Pat. No. 5,949,898 teaches a surround for a loudspeaker assembly. The outside edge of the surround is attached to the outer edge of the frame of the loudspeaker via a permanent or removable means. When removably attached, access to the mounting holes of the frame of the loudspeaker is accomplished by moving the roll to one side, prior to the attachment of the securing means. The method of attachment may include either the use of an annular o-ring or the use of a locking finger.

U.S. Pat. No. 5,734,734 teaches a voice coil adaptor ring and loudspeaker system of the moving coil type. The loudspeaker system includes a cone diaphragm supported by a frame, a voice coil former for supporting a voice coil, and a lower suspension for securing and centering the voice coil former in a magnetic gap while it is displaced by a magnetic circuit. The voice coil adaptor ring is mounted over the voice coil former and includes a substantially cylindrical sleeve which has a ledge extending outward from the sleeve for supporting the cone and lower suspension. An inner glue flange projects inward from the sleeve so as to define a diameter corresponding to an outer diameter of the voice coil former. The sleeve, the inner glue flange and the voice coil former define a gap for receiving epoxies. A plurality of venting passages are in fluid communication with a cap volume defined by the cone and a dust cap for venting hot air from the cap volume.

U.S. Pat. No. 6,224,801 teaches a method of making a speaker that includes providing a pair of dies. The dies between them define a cavity. A first portion of the cavity receives a diaphragm of the speaker. A second portion of the cavity adjacent an outer perimeter of the diaphragm receives a fluid thermoplastic elastomer for forming a diaphragm surround. The second portion includes a perimetrally inner first region adjacent the outer perimeter of the diaphragm for receiving the thermoplastic elastomer to form a perimetrally inner flange for bonding to the diaphragm adjacent the outer perimeter of the diaphragm. The second portion includes a central second region for receiving the thermoplastic elastomer to form a connecting arch of the surround. The second portion also includes a perimetrally outer third region for receiving the thermoplastic elastomer to form a perimetrally outer flange for attachment to a diaphragm support. A diaphragm is placed between the dies. The dies are closed. An amount of the fluid thermoplastic elastomer sufficient to fill the second portion is introduced into the cavity, and is permitted to solidify. This invention relates to transducers and particularly to a method of making a loudspeaker and a loudspeaker made by the method.

U.S. Pat. No. 3,997,023 teaches an injection-molded surround that attached to a speaker frame and a diaphragm by suitable adhesives.

U.S. Pat. No. 5,319,718 teaches a diaphragm that is provided with a closed-cell polyurethane foam surround by placing the diaphragm in a mold, depositing uncured foamable urethane around the perimeter of the diaphragm, closing the mold and permitting the foamable urethane to foam and cure in a cavity formed by the mold around the perimeter of the diaphragm. The urethane impregnates the exposed outer peripheral edge of the diaphragm, bonding it to the diaphragm, and forms a closed cell outer skin as it cures.

A method of making a speaker includes providing a pair of dies that defines between them a cavity. A first portion of the cavity is for receiving a diaphragm of the speaker. A second portion of the cavity adjacent an outer perimeter of the diaphragm when it is placed in the cavity receives a fluid thermoplastic elastomer for forming a diaphragm surround. The second portion includes a perimetrally inner first region adjacent the outer perimeter of the diaphragm for receiving the thermoplastic elastomer to form a perimetrally inner flange for bonding to the diaphragm adjacent the outer perimeter of the diaphragm when the fluid thermoplastic elastomer is introduced into the cavity. The second portion includes a central second region for receiving the thermoplastic elastomer to form a connecting arch of the surround when the fluid thermoplastic elastomer is introduced into the cavity.

The second portion also includes a perimetrally outer third region for receiving the thermoplastic elastomer to form a perimetrally outer flange for attachment to a diaphragm support when the fluid thermoplastic elastomer is introduced into the cavity. A diaphragm is placed between the dies. The dies are closed. An amount of the fluid thermoplastic elastomer sufficient to fill the second portion is introduced into the cavity, and is permitted to solidify.

U.S. Pat. No. 6,219,432 teaches a loudspeaker drive unit. The driver unit includes a diaphragm, a chassis member and a surround. The surround connects the outer portion of the diaphragm to the chassis member so that substantially all parts of the surround located between the diaphragm and the chassis member and capable of radiating sound are arranged parallel or at an acute angle with respect to the longitudinal axis of the loudspeaker drive unit, or the surround is made of a body of foam material arranged to be compressed against the chassis member when the diaphragm moves towards the chassis member, or the bending wave impedance of the surround is matched to the bending wave impedance of the diaphragm.

Known loudspeaker drive units include a diaphragm of which the outer portion is connected to a chassis member by way of a flexible surround.

U.S. Pat. No. 6,118,884 teaches a loudspeaker system of the moving coil type which includes a cone diaphragm supported by a frame, a voice coil former for supporting a voice coil, a lower suspension for securing and centering the voice coil former in a magnetic gap while it is displaced by a magnetic circuit and a voice coil adaptor ring. The voice coil adaptor ring is mounted over the voice coil former and includes a substantially cylindrical sleeve having at least one ledge extending outward from said sleeve for supporting the cone and lower suspension and a plurality of venting passages in fluid communication with a cone volume defined by the cone for venting hot air from the cone volume.

U.S. Pat. No. 5,111,510 teaches a speaker which includes a diaphragm integrally combined with a first frame piece and a driver unit integrally combined with a second frame piece.

U.S. Pat. No. 5,371,805 teaches a speaker which employs a diaphragm secured to a first periphery of an edge member and a frame secured to a second periphery of the edge member.

U.S. Pat. No. 5,323,469 teaches a conical loudspeaker which has a conical stabilizing element joined between an underside of a speaker membrane and an outside surface of a speaker moving coil carrier.

U.S. Pat. No. 5,424,496 teaches an electromagnetic converter. The converter includes an internal magnet system, a moving coil and tubular segment.

U.S. Pat. No. 4,764,968 teaches a disk-like diaphragm made from a conical plastic film and provided with vacuum formed support members which extend up to the disk-like radiating layer.

U.S. Pat. No. 4,118,605 teaches a coil mount structure which includes a cylindrical member, around one end portion of which a diaphragm edge is fixed, an inner peripheral edge portion where a damper is removably fixed, and an opposite end portion around which a coil is provided. Kobayashi does not provide any structure for ventilating air pressure from beneath the dust cap or a structure for creating a secure joint between the diaphragm/cone, spider, and/or voice coil. The structure of an adaptor-ring facilitates a stronger adhesive joint between the cone, spider, a voice coil bobbin and a means for venting air pressure buildup. There remains a need for a loudspeaker capable of providing improved structural joints between the speaker cone, spider, and voice coil former, allowing the use of smaller voice coil systems and providing ventilation in the speaker without forfeiting performance.

An acoustical piston suspension includes the curvature of a resilient sound radiating dome and the uniform recurring elongated stress relieving slots in the outer circumference of the upper surface of the curved piston suspension. This piston suspension assembly is manufactured from a single piece of resilient plastic material or from materials of similar resiliency. A reinforcing plastic film may be permanently affixed to the sound radiating dome to provide the necessary rigidity required for greater linear excursions in the radiating area and overall optimum effectiveness. The elongated stress-relieving slots are specifically designed to relieve those stresses created which are perpendicular to the radii of the suspension (along the concentric circles). This will leave only the bending-type stresses remaining, which lie along the radii of the suspension in the material between the slots. To enhance the resiliency and responsiveness of the piston suspension during operation, the reinforcing plastic film does not interfere with the curved piston suspension, i.e. elongated stress-relieving slots and the resilient material between the elongated slots. A single piece of resilient plastic material is utilized to make the curved sound radiating dome and the curved piston suspension structure in the improved acoustical transducer. The residual material within the elongated stress-relieving slots, which are incorporated in the outer circumference of the upper surface of the piston suspension, will prevent the activated air from moving from the front of the diaphragm to the rear of the sonic area that would result in sound cancellation. This material within the elongated stress-relieving slots has a predetermined thickness that is less than the thickness of the surrounding material of the curved piston suspension assembly.

The inventor hereby incorporates the above patents by reference.

### SUMMARY OF THE INVENTION

The present invention is directed to an electron-dynamic acoustical transducer. The transducer includes a frame, a diaphragm, a voice coil and a surround. The diaphragm is secured to the frame by the surround.

In a first aspect of the invention the surround is a single, large, semi-circular corrugation constructed from compressed neoprene foam rubber.

In a second aspect of the invention the surround has a plurality of radially distributed, relatively less-compressed areas.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### DESCRIPTION OF THE DRAWINGS

FIG. 1 is a schematic drawing of a loudspeaker.

FIG. 2 is a side elevation in cross-section of the loudspeaker of FIG. 1.

FIG. 3 is a side elevation of a loudspeaker that U.S. Pat. No. 4,138,594 teaches.

FIG. 4 is a side elevation of a loudspeaker that U.S. Pat. No. 3,912,866 teaches.

FIG. 5 is a side elevation of a loudspeaker that U.S. Pat. No. 4,313,032 teaches.

FIG. 6 is a cross-sectional view of the loudspeaker of FIG. 5 taken along the line 6-6 of FIG. 5.

FIG. 7 is a cross-sectional view of the loudspeaker of FIG. 5 taken along the line 7-7 of FIG. 5.

FIG. 8 is a schematic drawing of a loudspeaker that includes a compression chamber, a transducer and a straight horn.

FIG. 9 is a schematic drawing of the loudspeaker of FIG. 8 that includes a first transducer and a second transducer mechanically and acoustically coupled to the compression chamber.

FIG. 10 is a schematic drawing of a loudspeaker that includes a compression chamber, a transducer and a flat folded horn.

FIG. 11 is a schematic drawing of the loudspeaker of FIG. 8 that includes a transducer mechanically and acoustically coupled to the compression chamber.

FIG. 12 is a schematic drawing of a loudspeaker that includes a compression chamber, a transducer and a split bent horn.

FIG. 13 is a schematic drawing of the loudspeaker of FIG. 8 that includes a first transducer and a second transducer mechanically and acoustically coupled to the compression chamber.

FIG. 14 is a schematic drawing of a loudspeaker that includes a compression chamber, a transducer and a cornerless corner folded horn.

FIG. 15 is a schematic drawing of the loudspeaker of FIG. 8 that includes a transducer mechanically and acoustically coupled to the compression chamber FIG. 16 is a perspective drawing of a loudspeaker.

FIG. 17 is a partial perspective drawing of the loudspeaker of FIG. 16.

FIG. 18 is a perspective drawing of a loudspeaker.

FIG. 19 is a partial perspective drawing of the loudspeaker of FIG. 16.

FIG. 20 is an elevation in cross-section of an electron-dynamic acoustical transducer with a first surround.

FIG. 21 is an enlarged, elevation in cross-section of the first surround of FIG. 20.

FIG. 22 is an enlarged, elevation in cross-section of s a second surround.

FIG. 23 is an enlarged, elevation in cross-section of a third surround.

FIG. 24 is a perspective view of a subwoofer that U.S. Pat. No. 6,130,954 teaches.

FIG. 25 is an elevation in cross-section of the subwoofer of FIG. 25 taken substantially along the line 25-25 in FIG. 24 in order to depict a voice coil driven woofer and a mass driven woofer as they are mounted within a cabinet cube.

FIG. 26 is an enlarged elevation in cross-section of the voice coil driven woofer of FIG. 25.

FIG. 27 is an elevation in cross-section of the mass driven woofer and the voice coil driven woofer that include movable components. The movable components are a surround, a spider and mass of the mass driven woofer and a voice coil former, a voice coil, a speaker cone, a spider and a surround of the voice coil driven woofer.

FIG. 28 is a perspective drawing of a subwoofer that has a transducer and two passive radiators according to the present invention.

FIG. 29 is a side elevation of one of the two passive radiators of FIG. 28.

FIG. 30 is an elevation in cross-section of the subwoofer of FIG. 28 taken along the lines 30-30 of FIG. 28.

FIG. 31 is an elevation in cross-section of the subwoofer of FIG. 28 taken along the lines 31-31 of FIG. 28.

### DESCRIPTION OF THE PREFERRED EMBODIMENT

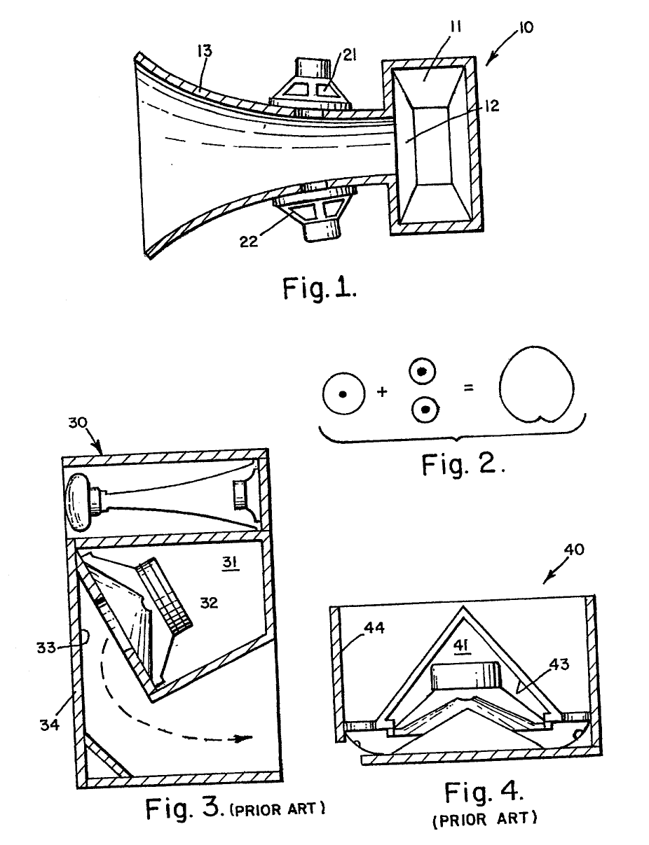

Referring to FIG. 1 in conjunction with FIG. 2 a loudspeaker 10 includes a compression chamber 11, a transducer 12 and a straight horn 13. The transducer 12 is disposed in the compression chamber 11. The output of the loudspeaker 10 is a monopole and therefore is omni-directional. A first transducer 21 and a second transducer 22 are mechanically and acoustically coupled to the straight horn 12. When the first and second transducers 21 and 22 are added to the transducer 12 their radiation output in the front of the loudspeaker 10 is a dipole and in phase augmentation sharing the monopath of the output of the transducer 12 and their output in the rear of the loudspeaker 10 is out of phase of with the output of the transducer 12. The combined monopole and dipole produces a cardiode-shaped wave. A typical sealed chamber horn radiation is omni-directional because the mouth area is small compared to the wavelength it is projecting, i.e. 36 feet at 30 Hz. An infinite horn would be directional. A practical horn rarely exceeds three feet in diameter. Hence the pattern is almost omni-direction in the thirty to ninety eight (30 to 98) Hz region also the effectiveness fall rapidly despite the taper near the thirty Hz cut-off usually beginning an octive higher. Klipsch in his article, entitled “A Low Frequency Horn of Small Dimensions”, published in The Journal Acoustical Society of America, Volume 13, Number 2, 1941, pages 137-144, derives the analytical expression for the volume of a back air chamber. Theoretically, the back air chamber should be about 10-20% larger to compensate for the flexure of the suspended diaphragm and for the immersed volume of the electromagnet of the electro-acoustic transducer. Since a 20% change in the volume of a back air chamber has been found to produce less than approximately 1 decibel of response error and since error toward a smaller back air chamber results in less modulation distortion due to subsonic inputs, the back air chamber preferably has a volume of 2,730 cubic inches, or 44.74 liters, so that the volume is only 2%, rather than 10-20%, larger than the analytical value.

Referring to FIG. 3 the loudspeaker 30 of U.S. Pat. No. 4,138,594 includes a compression chamber 31, a transducer 32 and a folded horn 33 in an enclosure 34. The transducer 32 is disposed in the compression chamber 31. The output of the loudspeaker 30 is a monopole and therefore is omni-directional.

Referring to FIG. 4 the loudspeaker 40 of U.S. Pat. No. 3,912,866 includes a compression chamber 41, a transducer 42 and a folded horn 43 in an enclosure 44. The transducer 42 is disposed in the compression chamber 41. The output of the loudspeaker 40 is a monopole and therefore is omni-directional.

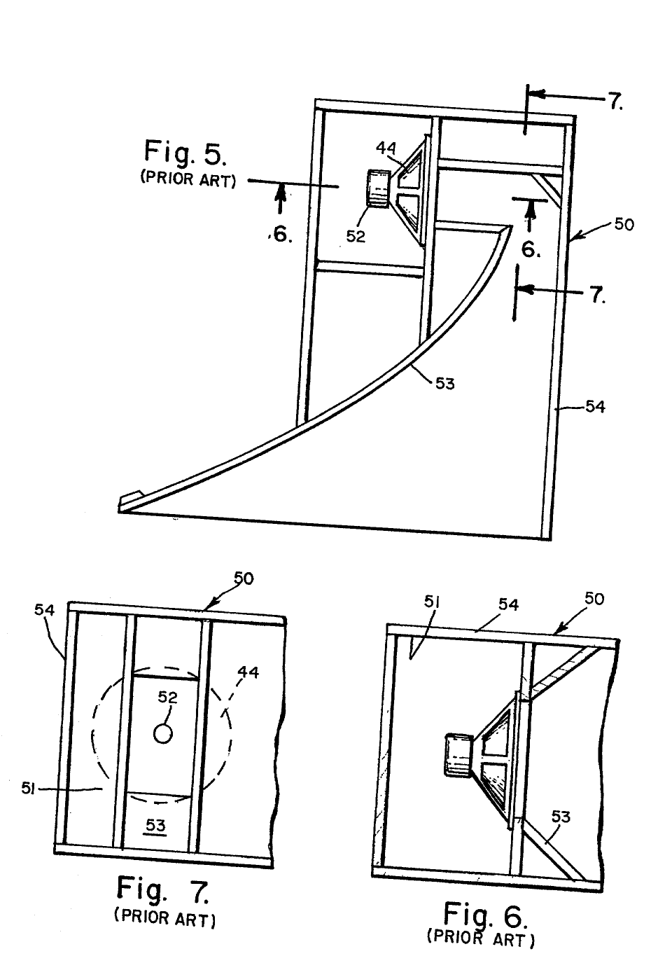

Referring to FIG. 5 in conjunction with FIG. 6 and FIG. 7 the loudspeaker 50 of U.S. Pat. No. 4,313,032 includes a compression chamber 51, a transducer 52 and a folded horn 53 in an enclosure 54. The transducer 52 is disposed in the compression chamber 51. The output of the loudspeaker 40 is a monopole and therefore is omni-directional.

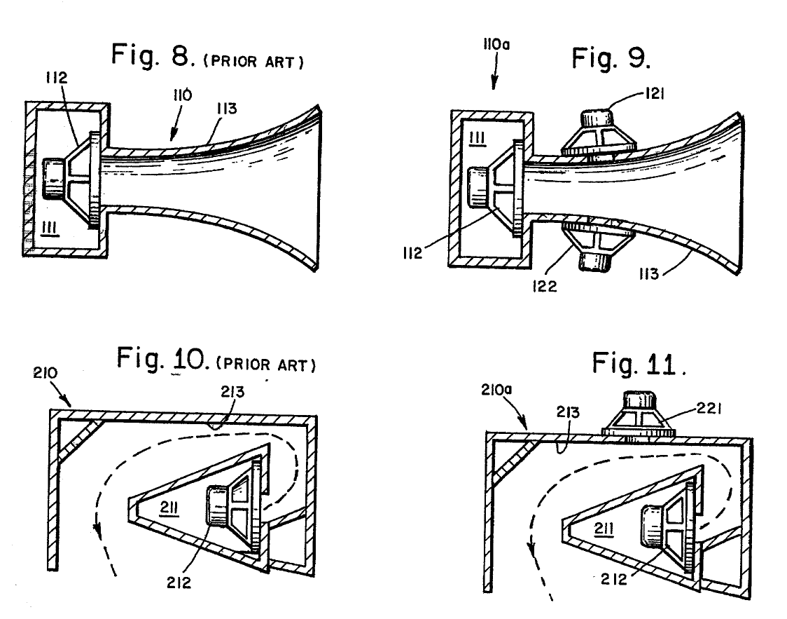

Referring to FIG. 8 and page 186 of a chapter on Enclosures in a book, entitled Hi-Fi Loudspeakers and Enclosure, Revised Second Edition, written by Abraham B. Cohen, published by Hayden Book Company Cohen describes a loudspeaker. A loudspeaker 110 includes a compression chamber 111, a transducer 112 and a straight horn 113. The transducer 112 is disposed in the compression chamber 111. The output of the loudspeaker 110 is a monopole and therefore is omni-directional.

Referring to FIG. 8 in conjunction with FIG. 9 a first transducer 121 and a second transducer 122 are mechanically and acoustically coupled to the straight horn 113. When the first and second transducers 121 and 122 are added to the transducer 112 their radiation output in the front of the loudspeaker 110 is a dipole and in phase augmentation sharing the monopath of the output of the transducer 112 and their output in the rear of the loudspeaker 110 is out of phase of with the output of the transducer 112. The combined monopole and dipole produces a cardiode-shaped wave.

Referring to FIG. 10 and page 186 of the book, entitled Hi-Fi Loudspeakers and Enclosure, a loudspeaker 210 includes a compression chamber 211, a transducer 212 and a flat folded horn 213. The transducer 212 is disposed in the compression chamber 211. The output of the loudspeaker 210 is a monopole and therefore is omni-directional.

Referring to FIG. 10 in conjunction with FIG. 11 a transducer 221 is mechanically and acoustically coupled to the flat folded horn 212. When the transducer 121 is added to the transducer 212 its radiation output in the front of the loudspeaker 210 is a dipole and in phase augmentation sharing the monopath of the output of the transducer 212 and their output in the rear of the loudspeaker 210 is out of phase of with the output of the transducer 212. The combined monopole and dipole produces a cardiode-shaped wave.

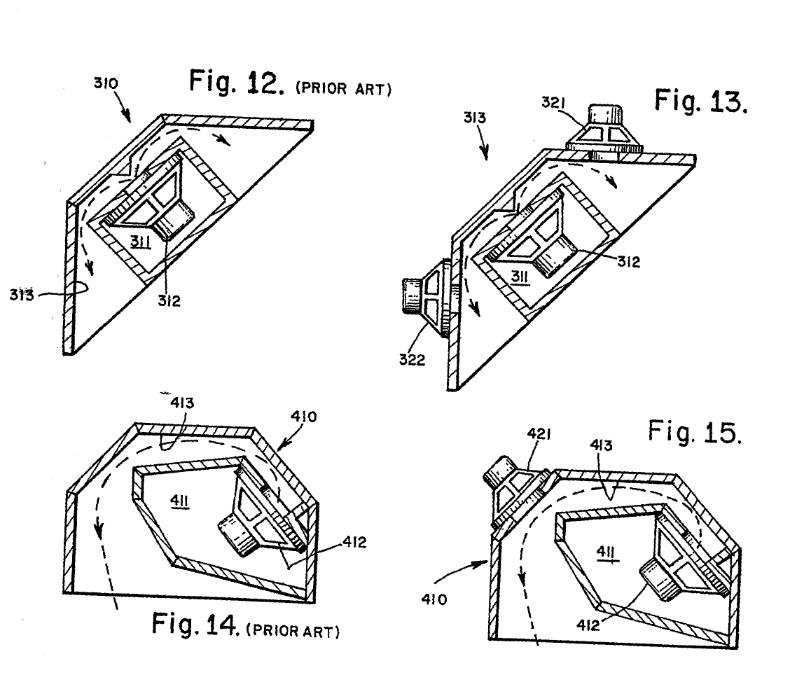

Referring to FIG. 12 and page 186 of the book, entitled Hi-Fi Loudspeakers and Enclosure, a loudspeaker 310 includes a compression chamber 311, a transducer 312 and a split bent horn 313. The transducer 312 is disposed in the compression chamber 311. The output of the loudspeaker 310 is a monopole and therefore is omni-directional.

Referring to FIG. 13 in conjunction with FIG. 12 a first transducer 321 and a second transducer 322 are mechanically and acoustically coupled to the split bent horn 312. When the first and second transducers 321 and 322 are added to the transducer 312 their radiation output in the front of the loudspeaker 310 is a dipole and in phase augmentation sharing the monopath of the output of the transducer 312 and their output in the rear of the loudspeaker 310 is out of phase of with the output of the transducer 312. The combined monopole and dipole produces a cardiode-shaped wave.

Referring to FIG. 14 and page 186 of the book, entitled Hi-Fi Loudspeakers and Enclosure, a loudspeaker 410 includes a compression chamber 411, a transducer 412 and a cornerless corner folded horn 413. The transducer 412 is disposed in the compression chamber 411. The output of the loudspeaker 410 is a monopole and therefore is omni-directional.

Referring to FIG. 14 in conjunction with FIG. 15 a transducer 421 is mechanically and acoustically coupled to the cornerless corner folded horn 412. When the transducer 421 is added to the transducer 412 its radiation output in the front of the loudspeaker 410 is a dipole and in phase augmentation sharing the monopath of the output of the transducer 412 and their output in the rear of the loudspeaker 410 is out of phase of with the output of the transducer 412. The combined monopole and dipole produces a cardiode-shaped wave.

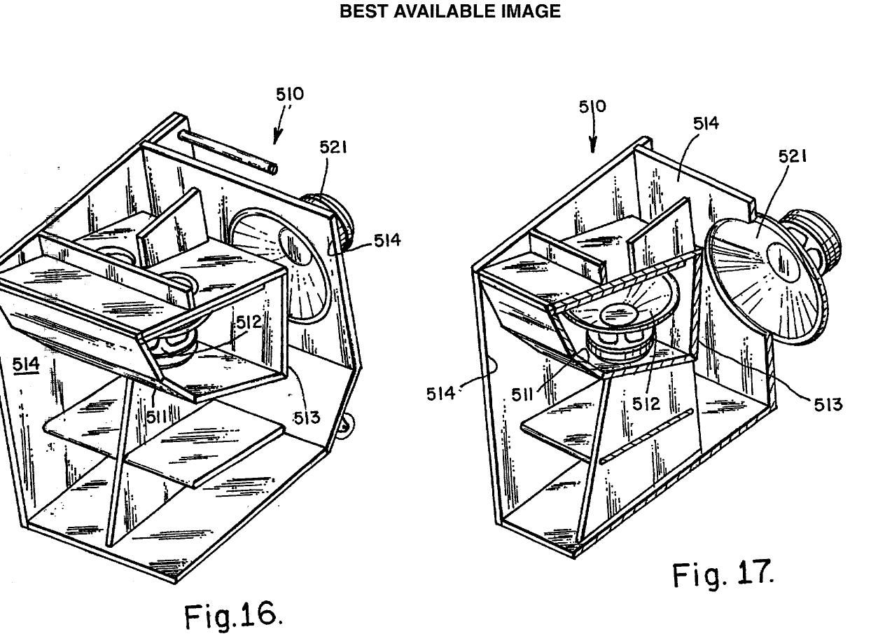

Referring to FIG. 16 in conjunction with FIG. 17 a first loudspeaker 510 includes a compression chamber 511, a first electro-acoustic transducer 512 and a flat folded horn 513 and a rectangular structure 514. The electroacoustic transducer 512 is disposed inside the compression chamber 511. The first loudspeaker 510 also includes a second electro-acoustic transducer 521 which is disposed outside the compression chamber 511 and is mechanically and acoustically coupled to the flat folded horn 513.

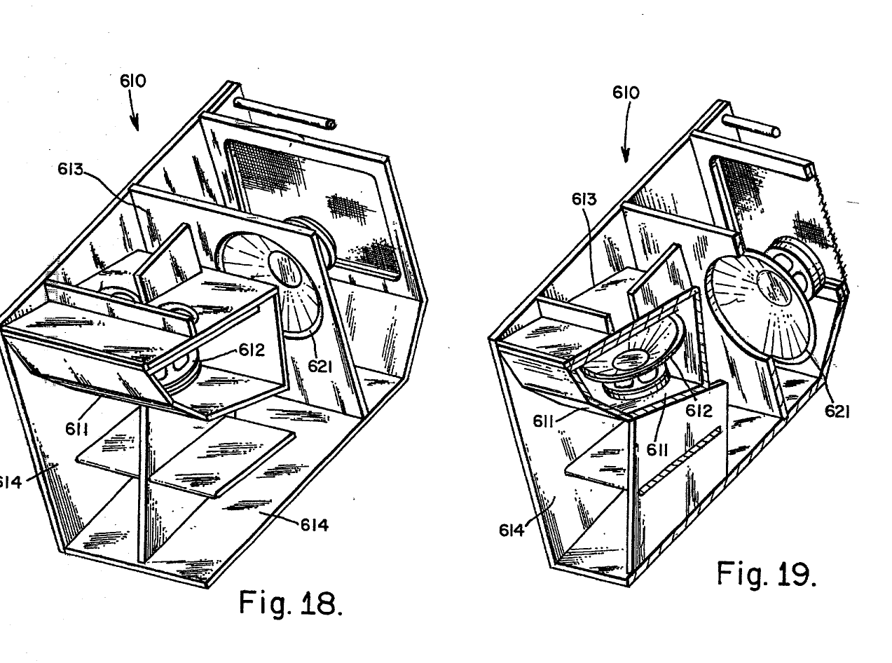

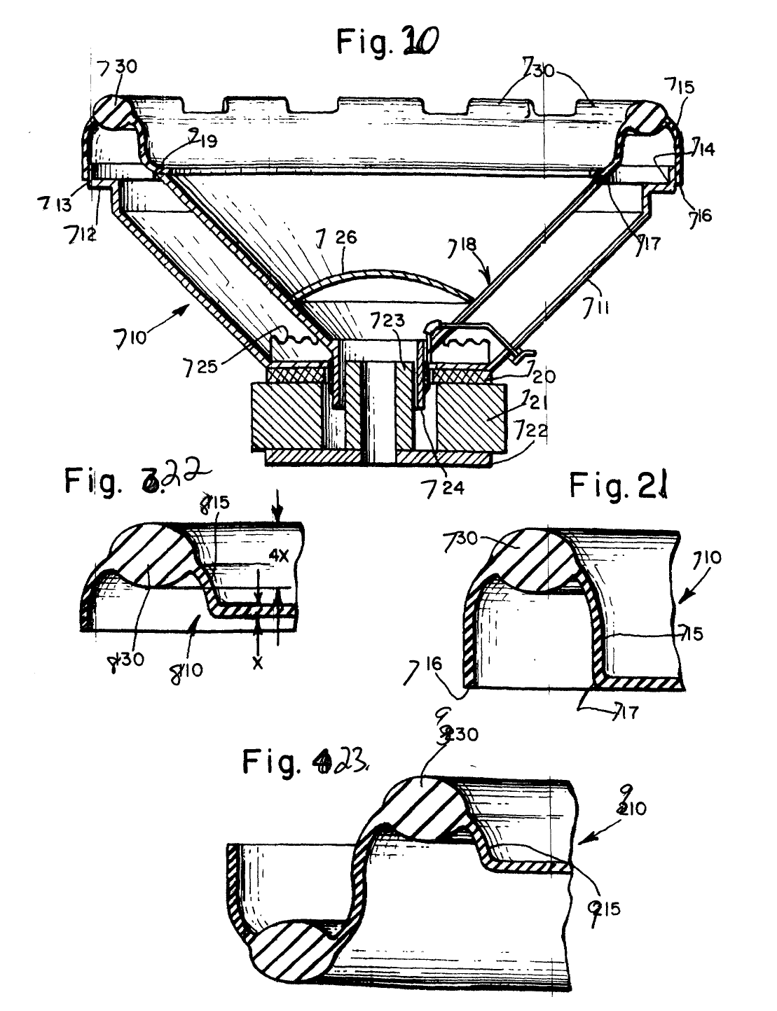

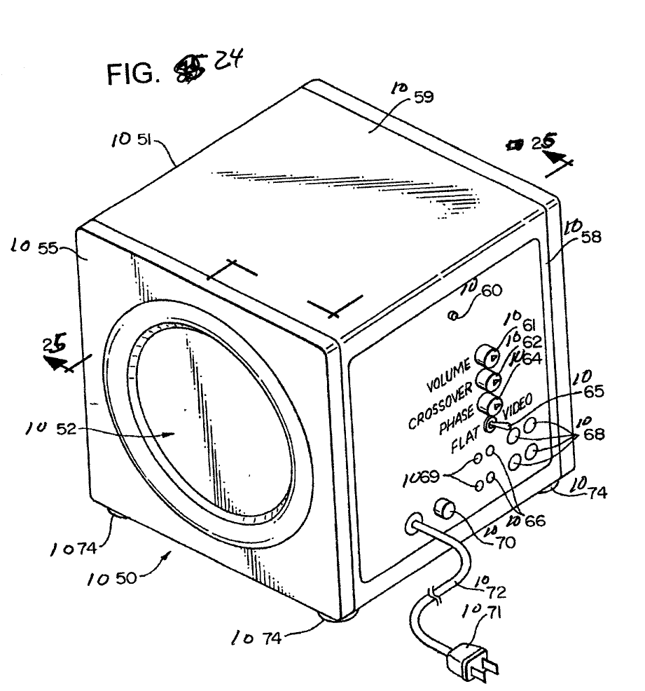

Referring to FIG. 18 in conjunction with FIG. 19 a second loudspeaker 610 includes a compression chamber 611, a first electro-acoustic transducer 612 and a flat folded horn 613 and a rectangular structure 614 with a rear extension 615. The electroacoustic transducer 612 is disposed inside the compression chamber 611. The second loudspeaker 610 also includes a second electroacoustic transducer 621 that is disposed outside the compression chamber 611 and is mechanically and acoustically coupled to the flat folded horn 613.

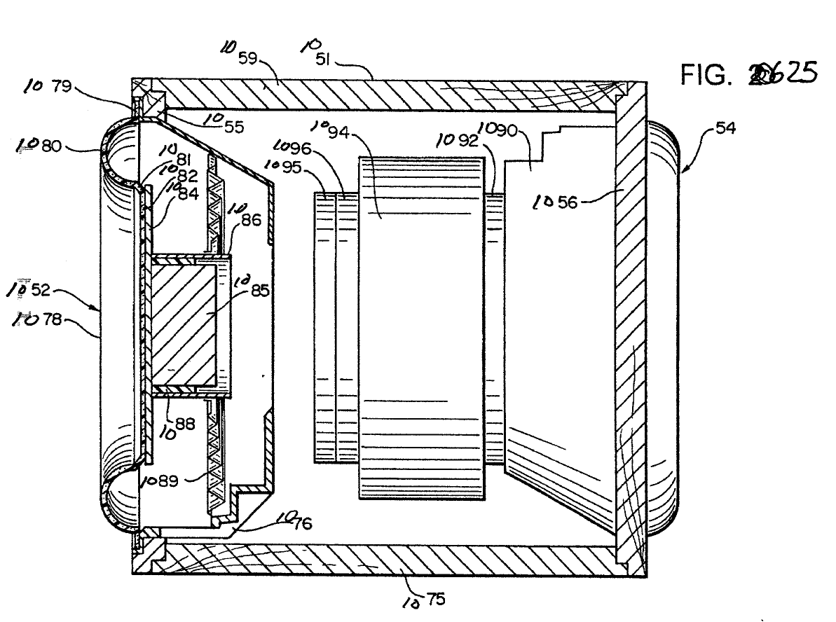

Referring to FIG. 20 a first loudspeaker 710 includes a loudspeaker frame 711 having an outer mounting flange 712. The outer mounting flange 712 includes an outer edge 713 and an inner edge 714. A first surround 715 has an outer periphery 716 and an inner periphery 717. The outer periphery 716 is attached to the mounting flange 712. The inner periphery 717 of the first surround 715 is attached to a diaphragm 718 at its outer periphery 719. The first surround 715 is attached to the mounting flange 712 and the diaphragm 718 by conventional means in the industry such as the application of adhesives.

Still referring to FIG. 20 the first loudspeaker 710 also includes a top plate 720, a magnet 721, a back plate 722, a pole piece 723 and a voice coil 724 and a spider 725. A magnetic gap is created between the inner edge of the top plate 720 and the pole piece 723. A dust cap 726 prevents foreign particles from entering the gap area. Wiring is also provided. The surround 715 is shown attached at its first outer periphery to the outer periphery of the mounting flange 712 of the frame 711, instead of inner periphery. A second inner periphery of the surround 715 is attached to the diaphragm 18 at its outer periphery.

Referring to FIG. 21 in conjunction with FIG. 20 the first surround 715 is U-shaped. The first surround 715 is formed from a single, large, semi-circular corrugation and is constructed by compressing neoprene foam rubber. The first surround 715 has a plurality of radially distributed, relatively less-compressed areas 730. One purpose of the first surround 715 is to help keep the diaphragm 718 centered and to provide a portion of the restoring force that keeps the voice coil 724 in the gap defined between the pole piece 723 and the top plate 720 of the first loudspeaker 710. The first surround 715 provides a damped termination for the edge of the diaphragm 718. The thickness of the first surround 715 can greatly alter the response of the first loudspeaker 710.

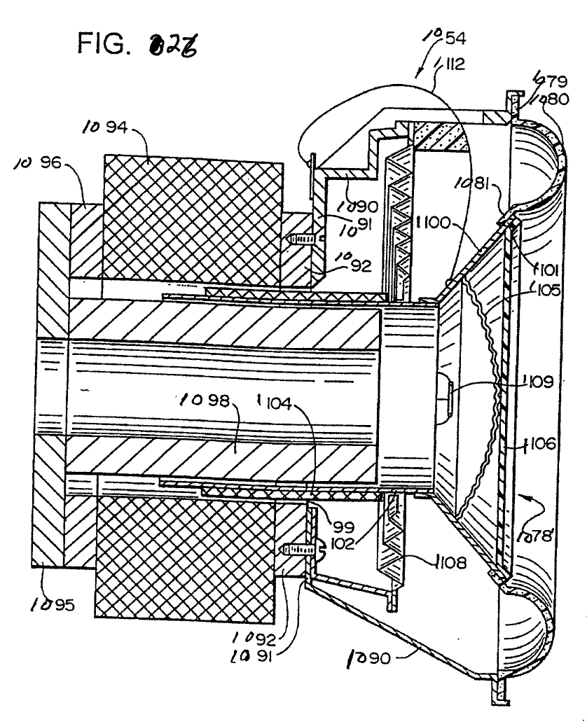

Referring to FIG. 22 in conjunction with FIG. 20 a second loudspeaker 810 includes a second surround 815. The second surround 815 includes a single, large, semi-circular corrugation constructed from compressed neoprene foam rubber. The second surround 815 is semi-circular in shape. The second surround 815 is formed from a single, large, semi-circular corrugation and is constructed by compressing neoprene foam rubber. The second surround 115 has a plurality of radially distributed, relatively less-compressed areas 830. One purpose of the second surround 815 is to help keep the diaphragm 718 centered and to provide a portion of the restoring force that keeps the voice coil 724 in the gap defined between the pole piece 723 and the top plate 720 of the second loudspeaker 810. The second surround 815 provides a damped termination for the edge of the diaphragm 718. The thickness of the second surround 815 can greatly alter the response of the second loudspeaker 810.

Referring to FIG. 23 in conjunction with FIG. 20 a third loudspeaker 910 includes a third surround 915. The third surround 915 includes a single, large, semi-circular corrugation constructed from compressed neoprene foam rubber. The third surround 915 is S-shaped. The third surround 915 has a plurality of radially distributed, relatively less-compressed areas 930. One purpose of the third surround 915 is to help keep the diaphragm 718 centered and to provide a portion of the restoring force that keeps the voice coil 724 in the gap defined between the pole piece 723 and the top plate 720 of the third loudspeaker 910. The third surround 915 provides a damped termination for the edge of the diaphragm 718. The thickness of the third surround 915 can greatly alter the response of the third loudspeaker 910.

Referring to FIG. 20 in conjunction with FIG. 21, FIG. 22 and FIG. 23 the thickness (4×) of the radially distributed, relatively less-compressed areas 730, 830 and 930 are four times the thickness (x) of the relatively more-compressed area of the remaining areas. The densities of the radially distributed, relatively less-compressed areas 730, 830 and 930 are one-fourth the density of the relatively more-compressed area of the remaining areas. Other ratios between the thicknesses of the radially distributed, relatively less-compressed areas 730, 830 and 930 and the thickness (x) of the relatively more-compressed area of the remaining areas may be used. The densities of the radially distributed, relatively less-compressed areas 730, 830 and 930 are the reciprocal (1/ratio) the density of the relatively more-compressed area of the remaining areas. These radially distributed, relatively less-compressed areas 730, 830 and 930 provide increased flexibility in a direction that is orthogonal to the diaphragm 718 without losing any rigidity in any direction within the plane of the diaphragm 718 because no material has been removed from the compressed neoprene foam rubber as in a slotted surround. U.S. Pat. No. 4,433,214 teaches the slotted surround.

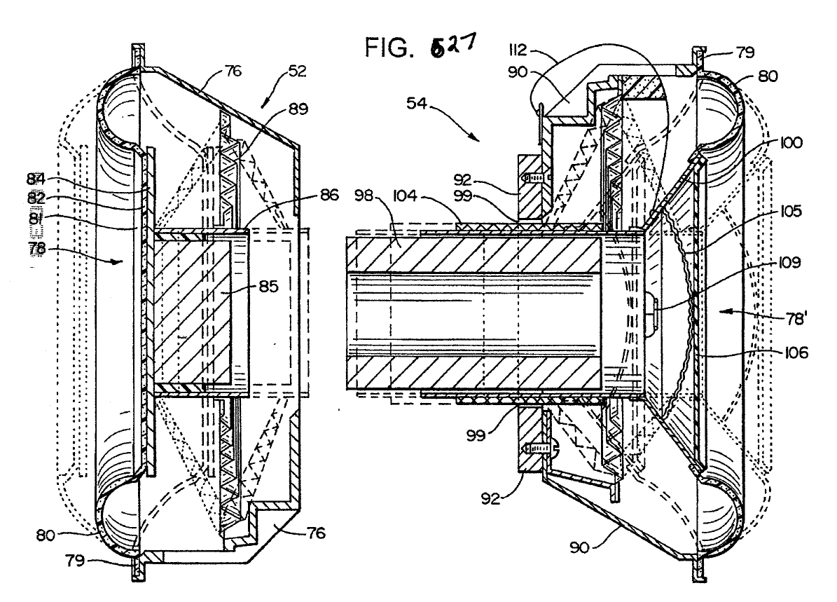

Referring to FIG. 24 in conjunction with FIG. 25 a subwoofer 1050 includes a cabinet 1051 that encloses two drivers 1052 and 1054. The drivers 1052 and 1054 are each oriented in a PUSH/PULL configuration on opposite sides of the cabinet 1051. The driver 1052 includes a mass driven driver and is mounted in one wall of the cabinet 1051 (here the left sidewall 1055 of the cabinet 1051) and fires in PUSH/PULL directions. The second driver 1054 is mounted in the opposite or right sidewall 1056 of the cabinet 1051 and simultaneously fires in corresponding PUSH/PULL directions. Both drivers 1052 and 1054 move simultaneously in a PUSH (or outward) direction and imultaneously in a PULL (or inward) direction. The cabinet 1051 is a substantially cubic structure with a front wall, a rear wall 1058 that includes a control panel, left and right sidewalls 1055 and 1056 within which the woofer drivers 1052, 1054 are mounted, a top wall 1059 and a bottom wall. All walls are constructed of a rigid, non-resonant, inert material such as MDF type particle-board, wood, or the like. Each panel or wall can have a suitable finish applied thereto such that the subwoofer can match the furnishings of the room where it will be installed. The drivers 1052, 1054 may, if desired, be covered by an acoustically transparent material. The rear wall 1058 containing the control panel a Power ON/OFF indicator light 1060, three control knobs for permitting manual adjustment of Bass Level 1061, Crossover Frequency 1062 and Phase 1064, a manually operable toggle switch 1065 for selecting between Video Contour and Flat operation, one pair of right and left female input jacks 1066 and one pair of right and left female input posts 1068 for permitting inputting of audio signals, one pair of right and left female output jacks 1069, a fuse 1070 and an A.C. outlet plug 1071 and power cord 1072. The audio signal input jacks 1066, 1068, 1069 can be connected to any suitable cables which bring the audio signal to the subwoofer 1050. The front, rear, side, top and bottom panels of the cabinet 1051 are fixed to each other to form the cabinet using known techniques. The cabinet 1051 is preferably sealed so that air can neither enter nor exit. Feet 1074 may be placed on the bottom panel 1075. The feet 1074 are of sufficient strength to support the subwoofer 1050, and formed of nonskid material capable of providing some sound or vibration insulation. The subwoofer 1050 employs two drivers that are the mass driven driver or woofer 1052 mounted in the left sidewall 1055 of the cabinet 1051 and the voice coil driven driver 1052 mounted in the right sidewall 1056 of the cabinet 1051. The mass driven woofer 1052 includes a stationary frame or cage 1076 mounted in the left sidewall 1055 of the cabinet 1051 for resiliently supporting the moving driver components in a stable manner. The movable driver components are constrained for PUSH/PULL movement axially out of and axially into the cabinet. The movable driver components in the mass driven driver 1052 includes a resilient, but semi-rigid, high pressure resistant surround 1078 formed of an expanded synthetic cellular foam as an expanded cellular polyethylene (“PE”) surround foam and including a generally circular element having an outer peripheral circumferential flange 1079, an annular half roll or “edgeroll” 1080 integral with the flange 1079 and terminating in an inner annular inturned or downturned integral flange 1081 which is, in turn, integral with a flat central disk portion 1082. A rigid backing plate 1084 formed of paperboard, plastic or the like is adhesively bonded to the central disk portion 1082 of the surround 1078. A round rod-shaped metal mass 1085 weighing approximately one and seven-tenths pounds (1.7 lbs.) is secured to the backing plate 1084 within a cardboard or paperboard cylindrical tube 1086 by means of a suitable epoxy glue 1088. Finally, the movable components of the mass driven woofer 1052—which collectively approximate two pounds (2.0 lbs.) in the aggregate—include an annular flexible spider 1089 having a corrugated cross-sectional configuration wherein the corrugations get progressively deeper towards the outer periphery of the spider 1089. The outer periphery of the spider 1089 is fixedly secured to the frame or cage 1076 of the mass driven woofer 1052, while its inner periphery is fixedly secured to the cylindrical cardboard or paperboard tube 1086 surrounding the mass 1085.

Referring to FIG. 26 in conjunction with FIG. 25 the voice coil driven woofer 1054 includes a stationary basket-like frame or cage 1090 which is fixedly mounted in the right sidewall 1056 of the cabinet 1051. The base of the frame 1090 includes an annular washer-shaped flange 1091 which is secured to an annular metal top spacer 1092 adjacent which is positioned an annular magnet 1094 having an external diameter of approximately 107 and 1 1/16 inches, an internal diameter of approximately 3½ inches, a depth of approximately 1.75 inches or slightly greater, and a weight of approximately 225 ounces (approximately 14 pounds, 1 ounce). The magnet 1094 comprises a single-piece magnet having a depth or length of approximately 1.75 inches; but, as those skilled in the art will appreciate, the magnet 1094 can be formed of two or more magnet segments which, when assembled in end-to-end relation, have the approximate dimensional and weight characteristics. The bottom face of the annular magnet 1094 is spaced from an annular metal bottom plate 1095 by an annular spacer 1096. The final stationary member of the voice coil driven woofer 1054 includes an annular pole piece 1098 having an external diameter of approximately 3 inches. The arrangement is such that the outer diameter of the annular pole piece 1098 defines an annular gap 1099—termed the “magnetic gap” between the pole piece 1098 and the upper annular spacer 1092 with the annular magnetic gap being approximately 0.1″ to about 0.25″ in radial width. The movable components of the voice coil driven woofer 1054 includes an expanded synthetic cellular foam surround 1078 that is an expanded cellular polyethylene (“PE”) foam surround, that is substantially identical to the surround 1078 employed with the mass driven woofer 1052 previously described except that the central disk-shaped portion 1082 of the surround 1078 associated with the mass driven woofer 1052 has been removed in the surround 1078′ employed with the voice coil driven woofer 1054, a speaker cone 1100 having a funnel shape with its outer large diameter end 1101 being adhesively bonded or otherwise fixedly secured to the inner inturned flange 1081 on the surround 1078′, a cylindrical voice coil former 1102 having an inner diameter slightly greater than the outer diameter of the annular pole piece 1098, a voice coil 1104 wound about the voice coil former and having an outer diameter slightly less than the inner diameter of the upper annular spacer 1092, a rigid dust cover or surround support 1105 having a shape comprising a segment of a sphere which is positioned within, and secured to, the funnel-shaped speaker cone 1100 with the domed portion of the dust cover/support facing outwardly; vi) a decorative cover 1106 formed of expanded cellular polyethylene (“PE”) surround foam, or similar material, positioned within, and secured to, the outermost large diameter end 1101 of the speaker cone 1100 with the decorative cover 1106 abutting the dust cover/support at their respective midpoints, and annular spider 1108 having a corrugated cross section wherein the depth of the corrugations progressively increase from the inner periphery towards the outer periphery with the spider 1108 being secured at its innermost periphery to the outer surface of the voice coil former 1102 and at its outer periphery to the frame or cage 1090 of the apparatus. The arrangement is such that when positive or negative voltage levels are output from the tracking down-converter-drive amplifier which is capable of delivering 2,700 watts rms to a nominal 4 ohm resistive load and swinging 104 volts rms-and applied to the voice coil 1104, current flows through the voice coil 1104 creating magnetic fields around the voice coil. These voice coil magnetic fields interact with the magnetic field of the magnet 1094, causing the voice coil former 1102, voice coil 1104, speaker cone 1100, dust cover 1105, surround 1078′, decorative cover 1106 and spider 1108 to move in an axial direction—e.g., in an outward axial PUSH direction when positive voltage levels are output from the tracking down converter-drive amplifier; and, in an inward axial PULL direction when negative voltage levels are output from the tracking downconvertor drive amplifier. The movable voice coil former 1102 and voice coil 1104 move axially within the magnetic gap 1099 between the annular pole piece 1098 and the annular upper spacer 1092 with a PUSH/PULL movement dependent upon the polarity of the voltage applied to, and the current flow in, the voice coil 1104. Since the voice coil former 1102 and voice coil 1104 reciprocate axially within the magnetic gap 1099—i.e., move to the left and to the right. The speaker cone 1100 attached to the right hand end of the voice coil former 1102 and 1105 reciprocates axially with the voice coil 1104 and voice coil former 1102. Such reciprocating movement is permitted because of the resilient nature and shapes of the surround 1078′—which is self supporting and semi-rigid and the spider 1108, which together represent the sole suspension mechanisms for the movable components of the voice coil driven woofer 1054. The surround 1078′ and spider 108—but particularly the surround 1078¹—are designed so as to be capable of permitting a peak-to-peak stroke of the movable driver components of up to about 2.5″, resisting or standing off internal box pressure ranging up to about 3 lbs/in.sup. and simultaneously supporting and stabilizing the moveable driver components on the longitudinal axis passing through the magnetic gap 1099 without significant or meaningful wobble. It will further be noted that an accelerometer 1109 is mounted in the speaker cone 1100 on the end of the voice coil former 1102. The accelerometer 109 serves to sense the movement of the movable components of the voice coil driven woofer 1054 and any movement distortion, with signals representative of such movement and any such distortions being conveyed to the processing circuitry discussed hereinafter.

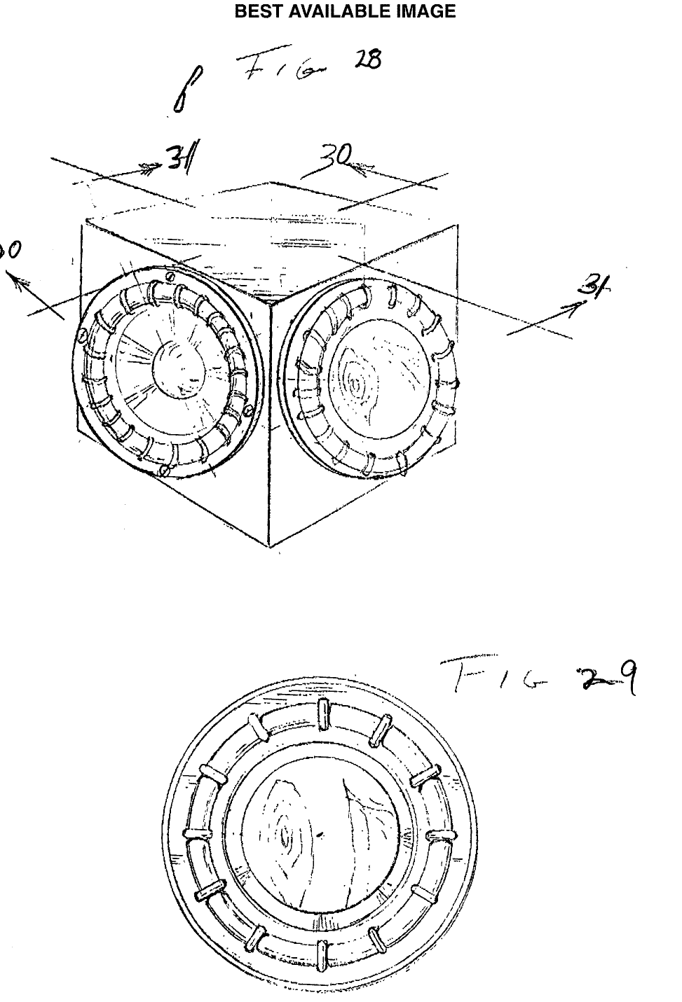

Referring to FIG. 27 in conjunction with FIG. 26 the surround 1078′ is intended for use in supporting a speaker cone 1100 having an effective 108″ diameter that would normally be mounted in a basket-like frame or cage 1090 having a diameter of approximately 10″. When the surround is intended for use with a speaker cone 1100 having an effective 10″ diameter and mounted in a basket-like frame or cage 1090 having a diameter of approximately 12″, the surround 1078′ will have a diameter of approximately 11.9″, a uniform thickness on the order of at least 0.14″, or more, an outer peripheral flange 1079 approximately 0.3875″ wide, and an edgeroll 1080 having an I.D. of approximately 1.5″. Conventional surrounds are, and have been, typically fabricated from, for example, an expanded cellular polyethylene (“PE”) surround foam sheet which is approximately 107/16″ in thickness and which is compressed to form a very resilient, compliant suspension member having a thickness of approximately 0.02″. Such conventional prior art surrounds are very thin and flexible, often having little more rigidity than rubber gloves; and, consequently, have very little ability to stand off internal pressures within the woofer box 1051. However, since conventional woofers generally generate internal pressures of only on the order of about 0.1 lbs/in.sup.2 to about 0.2 lbs/in.sup.2, and normally have peak-to-peak strokes of only 0.4″ to 0.6″, the conventional thin, highly flexible, compliant prior art surrounds have generally been acceptable. Typically such conventional surrounds will have an outer half roll or “edgeroll” of not more than, and usually less than, one inch in diameter. As will be described hereinbelow, the mass driven woofer 1052 and voice coil driven woofer 1054 of the present invention are driven through peak-to-peak excursions up to about 2.5″ as contrasted with conventional woofers which typically have peak-to-peak excursions ranging from only about 0.4″ to about 0.6″—i.e., the movable components of the drivers 1052, 1054 are driven to excursions ranging from five to six times the excursions typically generated in conventional subwoofers.

Referring to FIG. 28 a subwoofer 1210 includes a cabinet 1211, a transducer 1212 and two passive radiators 1220. The transducer 1212 and the two passive radiators are disposed in the cabinet 1211. The cabinet 1211 is substantially air-tight.

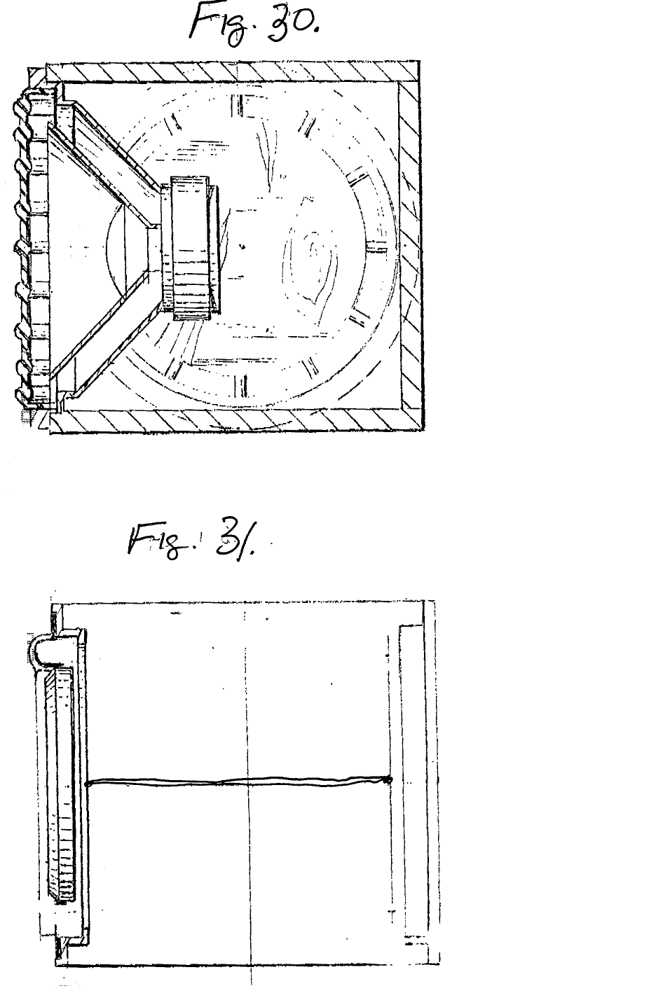

Referring to FIG. 29 each passive radiator 1220 includes a surround 1221 and a flat, circular piece 1222 of wood.

Referring to FIG. 30 in conjunction with FIG. 31 the subwoofer 1210 is disposed orthogonally to the two passive radiators 1212. The two passive radiators 1220 are resiliently coupled by an elastic member 1223 in order to overcome both the air pressure and the vacuum created by the push-pull action of the two passive radiators 1220.

While this invention has been particularly shown and described with references to preferred embodiments thereof, it will be understood by those skilled in the art that various changes in form and details may be made therein without departing from the spirit and scope of the invention as defined by the appended claims

It should be noted that the sketches are not drawn to scale and that distance of and between the figures are not to be considered significant.

Accordingly it is intended that the foregoing disclosure and showing made in the drawing shall be considered only as an illustration of the principle of the present invention.

What is claimed is:

1. A subwoofer comprising:
a. a cabinet;
b. a transducer disposed in said cabinet; and
c. two passive radiators disposed in said cabinet whereby said two passive radiators are disposed opposite to each other and orthogonal to said transducer. The transducer 1212 and the two passive radiators are. The cabinet 1211 is substantially airtight.

2. A surround for use in an electron-dynamic acoustical transducer including a frame, a diaphragm and a voice coil, said surround comprising a single, large, semi-circular corrugation being constructed from compressed neoprene foam rubber and being secured to the frame by the surround whereby said surround has a plurality of radially distributed, relatively less-compressed areas.
